(19) United States
(12) Patent Application Publication
(10) Pub. No.: US 2006/0046792 A1
(43) Pub. Date: Mar. 2, 2006

(54) Hinge apparatus and methods therefor

(76) Inventors: Brian J. Hassemer, Gurnee, IL (US); Roger W. Harmon, Crystal Lake, IL (US); Jason W. Meyer, Grayslake, IL (US); Zhengping D. Ding, Hainesville, IL (US); Kio Lee, Seoul (KR)

Correspondence Address: MOTOROLA INC, 600 NORTH US HIGHWAY 45, ROOM AS437, LIBERTYVILLE, IL, 60048-5343, US

(21) Appl. No.: 10/930,104

(22) Filed: Aug. 31, 2004

(51) Int. Cl. H04M 1/00

(52) U.S. Cl. 455/575.1; 361/681

(57) ABSTRACT

A collapsible device having first housing (110) rotateably coupled to a second housing (120) so as to rotate from a closed position (103) to an open position (200), wherein the first housing is angularly displaced from the second housing, for example in a wireless communications device. The first housing also moves relative to the second housing from a first closed position (101) to a second closed position (103). From the second closed position the first housing may rotate relative to the second housing about a rotation axis 106. In one embodiment the collapsible housing includes a slide enabling member that is rotatably coupled to the hinge and enables the first housing to move from the first closed position to the second closed position.

### FIELD OF THE INVENTION

The present invention relates generally to a closeable devices and, more particularly to hinged closable devices.

### BACKGROUND OF THE INVENTION

Wireless cellular communications devices having hinged flip portions are known generally. U.S. Pat. No. 6,549,789 entitled “Portable Electronic Device With An Adaptable User Interface” for example, discloses a handheld cellular telephone having a clamshell (i.e. collapsible or closeable) style housing wherein first and second housing portions are coupled by a universal hinge at an upper end portion of the device. In U.S. Pat. No. 6,549,789, the hinge rotates about a first axis allowing the housing portions to fold and unfold relative to each other. The hinge in U.S. Pat. No. 6,549,789 also rotates about a second axis perpendicular to the first axis. For example, a compression spring biased cam that engages a cam follower to pivot a housing member, such as a cover or flip portion, about an axis of rotation that is in the same plane as the compression spring is known.

Wireless or portable communication devices continue to add features while maintaining or even reducing the device size to promote portability. The existing hinges of folding devices take up space within the housing, which reduce the amount of already limited space that is available for the incorporation of other desirable features. Control over the motion of the relative housing portions is also limited. Additionally, the incorporation of an auto open feature is limited, takes up valuable space within the device or is not possible with the existing hinge assemblies.

Some hinges force a spring urged follower into a detent cam, positioning the two elements at various angles relative to one another, based on the position of the detent. These hinges, however, do not control the motion of one element relative to the other element.

Some devices maintain the closed position with detents or cams that are incorporated into he hinge portion of the device. One device employs a magnetic field in one housing of the device that may be turned off and on selectively. The magnetic field when on, attracts a magnetically attracted material such as another magnet or a ferrous material of the other housing to hold the device closed. The device opens or is disengaged when the magnetic field is turned off. However, this magnetic engagement requires the operation of toggling the magnetic field on or off to open and close the device.

The various aspects, features and advantages of the present invention will become more fully apparent to those having ordinary skill in the art upon careful consideration of the following Detailed Description of the Invention with the accompanying drawings described below.

### BRIEF DESCRIPTION OF THE DRAWINGS

FIG. 1 is an exemplary cross sectional view of a device having a hinged portion.

FIG. 2 is an exemplary device in a open position.

FIG. 3 is an exemplary cut away view of a hinge portion.

FIG. 4 is an exemplary cut away view of a hinge portion.

FIG. 5 is an exemplary cut away view of a hinge portion.

FIG. 6 is an exemplary cross sectional top view of a hinge portion and slide enabling portion.

FIG. 7 is an exemplary cross sectional front view of a slide enabling portion.

FIG. 8 is an exemplary sectional view of a fixturing portion.

FIG. 9 is an exemplary cross sectional view of a device having a hinged portion.

FIG. 10 is an exemplary cross sectional view of a device having a hinged portion.

FIG. 11 is an exemplary wireless communications handset schematic block diagram.

FIG. 12 is an exemplary wireless communications handset schematic block diagram.

FIG. 13 is an exemplary engaging portion of the collapsible device.

FIG. 14 is an exemplary wireless communications handset schematic block diagram.

### DETAILED DESCRIPTION OF THE DRAWINGS

While the present invention is achievable by various forms of embodiment, there is shown in the drawings and described hereinafter present exemplary embodiments with the understanding that the present disclosure is to be considered an exemplification of the invention and is not intended to limit the invention to the specific embodiments contained herein. It is further understood that the hinge mechanisms of the present invention may be used more generally in any application where it is desirable to provide a collapsible device as will become more fully apparent from the discussion below.

A collapsible housing is disclosed that includes a first housing and a second housing. A hinge is coupled to one of the first housing or the second housing that allows the first housing to rotate relative to the second housing about a rotation axis of the hinge and collapse together. The first housing also moves relative to the second housing from a first closed position to a second closed position in the collapsed configuration. From the second closed position the first housing may rotate relative to the second housing about the rotation axis. In one embodiment the collapsible housing includes a slide enabling member that is rotatably coupled to the hinge and enables the first housing to move from the first closed position to the second closed position. The slide enabling member is slideably coupled to one of the first housing or the second housing which ever is not coupled to the hinge such that the first housing or the second housing slides radially relative to the rotation axis.

In one embodiment a latching or engaging member carried on one of the first housing or the second housing attracts or selectively affixes the first housing to the second housing in one of the first or second closed positions. The slide enabling member allows the first housing to move radially relative to the rotation axis and laterally relative to the second housing to a second closed position thereby disengaging the latching member. Once the collapsible housing is in the second closed position the first housing may then angularly configure relative to the second housing about the rotation axis. The angular configuration may be assisted by a biasing force or may be a manual operation or a combination thereof.

FIG. 1 illustrates an exemplary collapsible electronic device 100 in a closed position 101. In this exemplary embodiment, the electronics device 100 is a radiotelephone. The radiotelephone 100 described herein is a representation of the type of wireless communication device that may benefit from the present invention. However, it is to be understood that the present invention may be applied to any type of hand-held or portable electronic device including, but not limited to, the following devices: radiotelephones, cordless phones, paging devices, personal digital assistants, portable computers, pen-based or keyboard-based handheld devices, remote control units, portable media players such as an audio player (such as an MP3 player) and the like. Accordingly, any reference herein to the radiotelephone 100 should also be considered to apply equally to other hand-held or portable electronic devices.

The device 100 is shown in the exemplary closed position 101 wherein a first housing 110 is planalry adjacent to a second housing 120. The first housing 110 is movably coupled to the second housing 120. The first housing 110 is pivotally coupled to the second housing 120 by a hinge 102 which has a rotation axis 106. The hinge 102 may also be coupled to a slide enabling member 104. The second housing 120, for example a radiotelephone phone flip, is moveblay coupled to the slide enabling member 104. The hinge 102 couples the first housing 110 to the slide enabling member 104 and effectively to the second housing 120, allowing the second housing 120, and the slide enabling member 104, to rotate relative to the first housing 110 about the rotation axis 106 of the hinge 102 relative to the second housing 120.

The slide enabling member 104 coupled to the second housing 120 rotates about the rotation axis 106 relative to the first housing 110. Additionally, in this exemplary embodiment, the second housing 120 slides along the slide enabling member 104 radially relative to the rotation axis 106. The second housing 120 may slide from a first closed position 101 to a second closed position 103. This hinge 106 allows the housings to then configure from the second closed position 103 and an open position 200. In the first closed position 101 and the second closed position 103, the first and second housings 110, 120 respectively are in a stacked configuration such that they are planalry adjacent 101, 103, such that a first face 114 of the first housing 110 is substantially planarly adjacent to a second face 116 of the second housing 120. In the first closed position 101 the second housing 120 may only move laterally, substantially in the same plane, relative to the first housing 110 along the slide enabling member 104 and cannot rotate about the rotation axis 106. The second housing 120 may only angularly configure until it is laterally moved out of the closed position 101 to or at least in the direct of the second closed position 103.

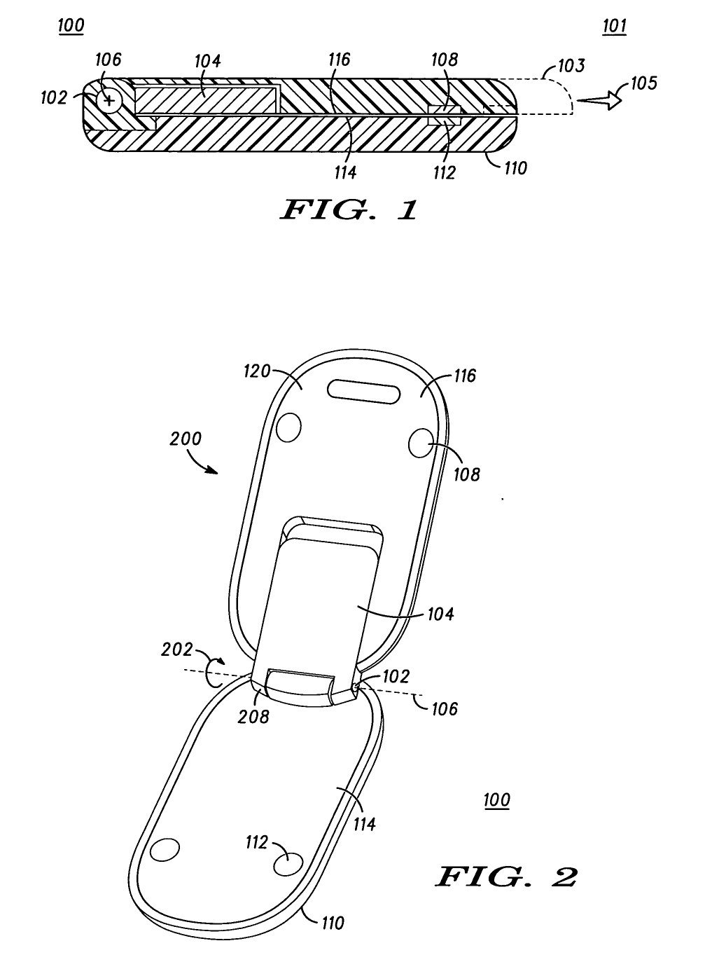

Once moved out of the first closed position 101, the second housing 120 may rotate from the second closed position 103, wherein the second housing 120 is still planalry adjacent to the first housing 110 in the stacked configuration, to the open position 200, as in the exemplary embodiment shown in FIG. 2, wherein the second housing 120 is angularly configured about the rotation axis 106 relative the first housing 110. The angular configuration is indicated by arrow 202. The direction the second housing 120 slides relative to the first housing 110 depends on the angle of rotation 202 about the rotation axis 106.

The first housing 110 is held or selectively restrained in the closed position 101, i.e. planalry adjacent to the second housing 120, by engaging members. The first housing 110 carries a first engaging member 108 and the second housing 120 carries a second engaging member 112. The first engaging member 108 and the second engaging member 112 are complimentary such that they may be selectively engaged. In the first closed position 101, wherein the first housing 110 and the second housing 120 are planarly adjacent, the first engaging member 108 is engaged to the second engaging member 112 holding the first housing 110 adjacent to the second housing 120 in the closed position 101. Sliding the first housing 110 relative to the second housing 120, in the direction indicated by arrow 105 from the first closed potion 101 to the second closed position 103 moves the first engaging member 108 relative to the second engaging member 112. In this embodiment, this lateral movement disengages the first engaging member 108 from the second engaging member 112 such that the first housing 110 is free to rotate about the rotation axis 106 relative to the second housing 102 on disengaged. Therefore to open the device 100 in this exemplary embodiment, the second housing 120 is moved from the first closed position 101 to the second closed position 103 which thereby disengages the first engaging member 108 from the second engaging member 112. Once disengaged, the second housing 120 is free to rotate from the second closed position 103 to the first open position 200 (FIG.2).

In one exemplary embodiment the hinge 102 includes a biasing member 302, shown in FIG. 3. In this exemplary embodiment, the biasing member 302 is carried at the hinge 102. The biasing member 302 exerts a biasing force 304 on the first housing 110 and the second housing 120 to bias the first housing 110 so as to automatically angularly configure from the second closed position 103 to the first open position 200 relative to the second housing 120. The biasing member 302 operates in conjunction with the first and second engaging members 108, 112. When in the first closed position 101, the two housings 110, 120 are engaged by the first engaging member 108 and the second engaging member 112 overcoming the biasing force 304 of the biasing member 302 thereby holding the first housing 110 adjacent to the second housing 120. As is known to one of ordinary skill in the art, the biasing member 302 may be a torsion spring incorporated into to the collapsible or folding device in various ways to exert a biasing force between the first and second housings 110, 120. Although a torsion spring is one exemplary biasing member, other forms of the biasing member, such as a compression spring, may achieve the same result as is understood by those skilled in the art.

In FIG. 3, an exemplary cut away view shows the biasing member and housing 100 assembly. The biasing member is a torsion spring 302 in this exemplary embodiment coupled between the slide enabling member 104 and the first housing 110. The torsion spring 302 has a first end 306 and a second end 308 that coupled to the slide enabling member 104 and the first housing 110 respectively. A coil portion 310 of the torsion spring is carried in a hinge portion 312 of the first housing 110. The coil portion 310 is coiled around a hinge shaft 314 of the hinge portion 312. The hinge shaft 314 extends from the slide enabling member 104 though a first void 316 in the hinge portion 312, through the torsion spring 302, through a second void 318 in the hinge portion 312. The rotation axis 106 runs through the center of the hinge shaft 314 in this exemplary embodiment.

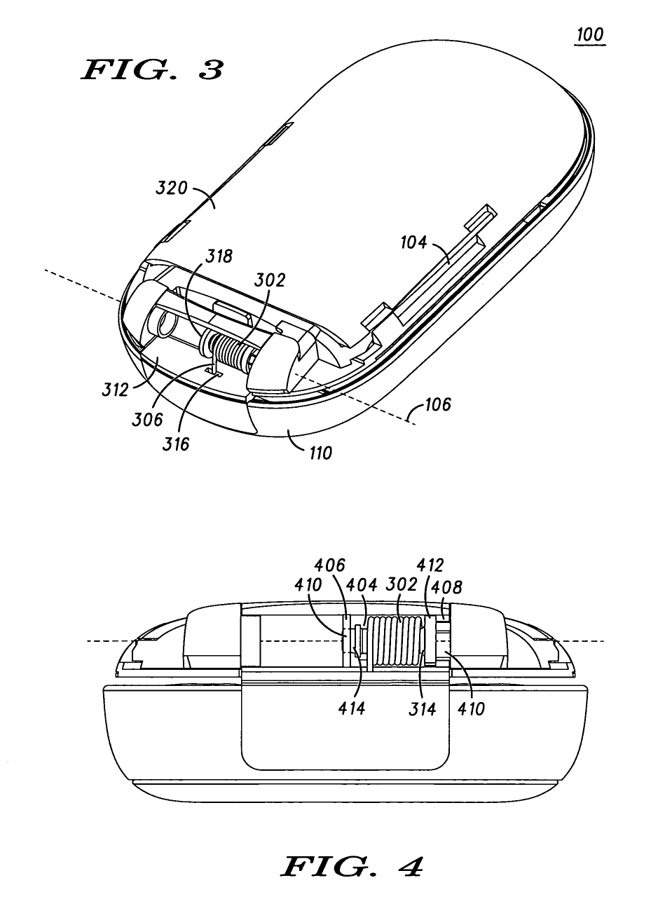

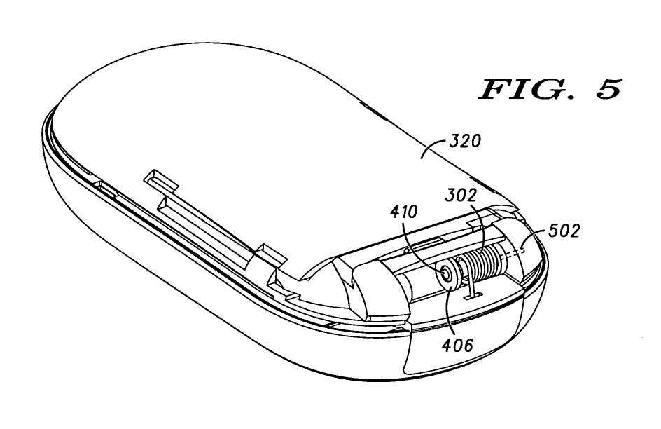

FIG. 4 shows an exemplary hinge portion 312 viewed in cross section form. The void 316 that is adapted to receive a first torsion spring end 306 is a slot 316 in the hinge portion 312. The slot retains the first torsion spring end 306 and secures the torsion spring 302 such that it coils when the first housing 110 is rotated about the rotation axis 106 relative to the second housing 120. The torsion spring 302 is enclosed by the hinge portion portion 312. The slot retains the first torsion spring end 306 and secures the torsion spring 302 such that it coils when the first housing 110 is rotated about the rotation axis 106 relative to the second housing 120. The torsion spring 302 is enclosed by the hinge portion cavity 404. A first shaft retaining member 406 and a second shaft retaining member 408 secure the shaft within the hinge portion 312. The first shaft retaining member 406 and the second shaft retaining member 408 may have a bearing surface on an inner portion 410 that comes in contact with the hinge shaft 314.

FIG. 5 illustrates, in a cut-away view, the slide enabling member 104 and the torsion spring 302 assembly. The hinge shaft 314 has a first shaft end 412 that is adjacent to the slide enabling member 104. The hinge shaft 314 in this exemplary embodiment is coupled to the slide enabling member 104 at the first shaft end 412 slide enabling member interface. A second torsion spring end 502 of the torsion spring 302 engages a void 504 in at least the first hinge shaft end 412 and may also extend into the slide enabling member 104. In this exemplary embodiment, the void 504 in the slide enabling member 104 is a circular hole adapted to receive the second torsion spring end 502. A second shaft end 414 engages the first shaft retaining member 406.

Referring to FIGS. 3-5, the first torsion spring end 320 and the second torsion spring end 502 rotate relative to one another as the first housing 110 is rotated about the rotation axis 106 relative to the second housing 120. In the first and second closed position 101, 103, the torsion spring 302 is preloaded in a coiled state or wound state exerting a biasing force on the two housings. As the housings rotate to the first open position 200, the torsion spring 302 uncoils until the second housing 120 stops in the open position 200. The torsion spring 302 may or may not be under torsion when the device 100 is in the first open position 200. The torsion spring 302 may still be in a coiled configuration but remain at rest without exerting any biasing force in the first open position. In this exemplary embodiment, the torsion spring 302 remains under torsion and in a coiled configuration when the device is in the first open position 200, and still exerts a biasing force on the first housing 110 and the slide enabling member 104 thereby holding the device 100 in the first open position 200. In another embodiment, the spring may completely relax, although still coiled, and exert substantially zero biasing force on the housings 110, 120. In this embodiment, a cam in the hinge or a detent temporarily secures the device 1200 in first open position 200. One of ordinary skill in the art will understand that other biasing mechanisms as well as variations of the above may be used to achieve automatic or assisted angular configuration of the first and second housings 110, 120.

In reference again to FIG. 1, an exemplary cross section of a collapsible device 100 is shown in the first closed position 101. In this embodiment, the first housing 110 has an elongated shape with at least the first face 114. The second housing 120 has a similar elongated shape with the second face 116. In the first closed position 101 the second housing 120 substantially covers the first housing 110 wherein the first face 114 and the second face 116 are substantially planarly adjacent. The housings do not have to be substantially the same shape as in the exemplary embodiment. For example, the second housing may be a cover that only cover a portion of the first housing, e.g. to protect a keypad carried on the first housing 110. The housings 110 and 120 rotate relative to one another. In this exemplary embodiment, the first housing 110 rotates relative to the second housing 120 about the rotation axis 106 which is substantially in the same plane as at least the first face 114 of the first housing 110. The first and second housings 110, 120 are adapted to carry electronics in the exemplary embodiment shown in FIGS. 1-4. In other exemplary embodiments electronics may be carried in either the first housing 110 or the second housing 120. For example, when the second housing 120 is a cover substantially all of the electronics may be carried in the first housing 110. In one exemplary embodiment, the cover only carries the engaging member 108 and may be either the magnet 108 or the ferrous material 108 or the like as discussed in previous exemplary embodiments.

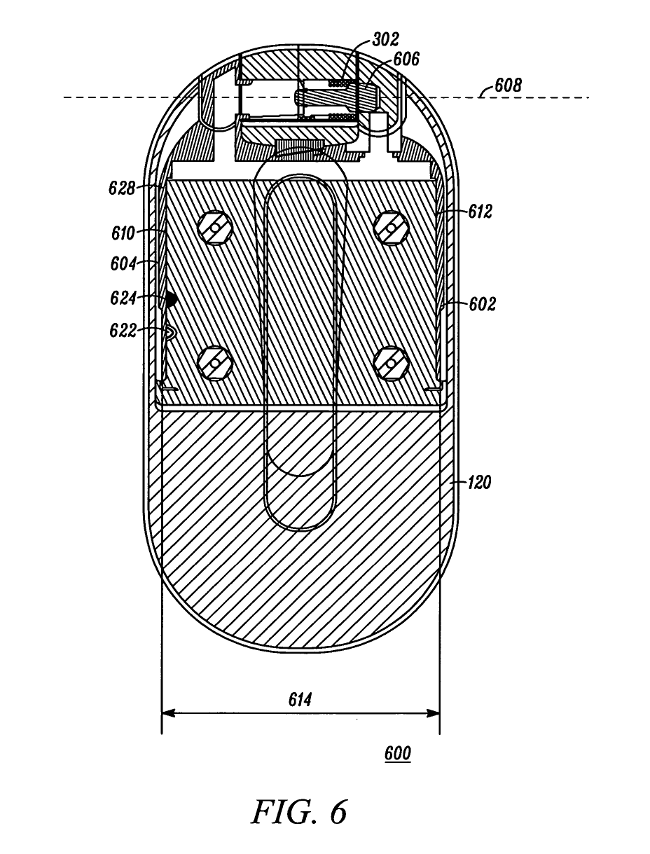

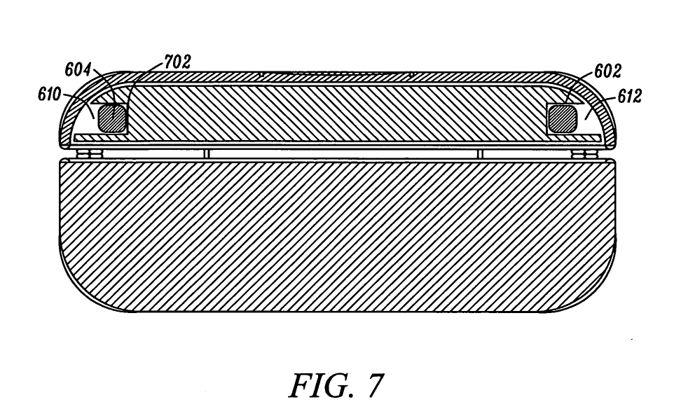

Moving to an exemplary embodiment shown in FIG. 6 and 7, the slide enabling member 104 is shown from the top view cross section (FIG. 6) and from a front view cross section (FIG. 7). In this exemplary embodiment, the slide enabling member 104 is comprised of a first rail 602 and a second rail 604 that engage with the second housing 120. The first rail 602 and the second rail 604 are coupled to the hinge shaft 606 of the hinge portion 607. In this exemplary embodiment, the rails 602 and 604 extend radially from the hinge shaft 606 and the rotation axis 608 and rotate about the rotation axis 608 of the hinge 606. The second housing 120 has a first rail engaging portion 610 and a second rail engaging portion 612 in which the rails 602, 604 slideably engage the second housing 120. The first rail engaging portion 610 and a second rail engaging portion 612 may be independant pieces coupled to eh second housing or formed as a port of the second housing 120. Each rail engaging portion 610, 612 may be a track 610, 612 that is carried on the second housing 120 that slideably retains and guides the first rail 602 and the second rail 604. The track 610, 612 may include a plurality of side surfaces or may be a continuous curved or a curved surface in nature. In the exemplary embodiment, the track 610, 612 is complimentary in shape to the shape of first rail 602 and the second rail 604. The shape of the first rail 602 and the second rail 604 may be the same as in the exemplary embodiment or may each take on a different shape. The second housing 120 slides along the tracks 610, 612 on the first rail 602 and the second rail 604 respectively between the first closed position 101 to the second closed position 103.

In one exemplary embodiment, each rail is a shaft, such as a cylindrical shaft, that engages the rail engaging portions 610 of the second housing 120. In this embodiment the rail engaging portions 610, 612 are cylindrical bearings adapted to slidably engage the cylindrical shaft. In one embodiment only one shaft is to be used with a complimentary bearing set. The rails may take on a shape other than cylindrical. For example, the rails may be flat, square, cylindrical, or any shape as long as they are complimentary with the track to allow the sliding motion of the second housing 120 along the rail.

Each rail engaging portion 610, 612 may have a bearing or bearing surface that effects or controls the amount of the friction between the second housing 120 relative to the first rail 602 and the second rail 604. The bearing surface may be low friction surface layer such as Teflon or the like. The bearing surface may also be ball bearings or a lubricating material or a combination thereof. A bearing or bearing surface may not be used at all and the first and second rail engaging portions 610, 612 are in direct contact with the first rail 602 and the second rail 604. In another exemplary embodiment, the rails, 602, 604 and the first and second rail engaging portions 610, 612 are constructed out of a metal material such as aluminum or spring steel. A bearing surface may or may not be applied to the one or both the rail and the rail engaging portion.

In the exemplary embodiment, the first rail 602 and the second rail 604 are parallel and separated by a rail separation distance 614. The rail separation distance 614 in the exemplary embodiment is a distance that is great enough that an electronic display 320 (FIG. 3) may fit between the two rails 602 and 604 in this exemplary embodiment. The rail separation distance 614 may be set at a distance that minimizes torsional rotation of the second housing 120 relative to the first housing 110, substantially maintaining the second housing 120 in the same plane as the rotation axis 608.

In one exemplary embodiment, at least one of the first rail 602, the second rail 604, the first rail engaging portions 610 or second rail engaging portions 612, or any combination thereof includes a fixturing portion 620 that selectively fixes, i.e. temporarily locks into place, the second housing 120 at one or more locations along the first and second rail 602, 604. In one exemplary embodiment the fixturing portion 620 is a spring finger 620 coupled to one of the first or second rails 602, 604 or one of the first or second rail engaging portion 610, 612 of the second housing 120. The spring finger 620 selectively fixes the second housing 120 in at least one of the first closed position 101 or the second closed position 103 for example. In this exemplary embodiment, the spring finger 620 is carried on one of the first rail 602 or the second rail 604. The spring finger 620 may be carried on any portion of the rail 602 that is adjacent to the rail engaging portions 610, 612 of the second housing 120. In this embodiment, the fixturing portion 620 is adapted to temporarily engage a first detent 622 of the rail engaging portions 610, 612 (chassis) of the second housing 120.

In this exemplary embodiment the first detent 614 is located along a surface 702 of the rail engaging portion 610 of the second housing 120. Although one rail is discussed in the following exemplary embodiment, a detent may be applied to either of the rails, 602, 604 or both rails of the exemplary embodiment shown in FIG. 6 and FIG. 7. The spring finger 620 slidably engages with the first detent 622 selectively affixing the position of the second housing 120 at a first rail position 600. In this exemplary embodiment the first rail position 600 corresponds to the first closed position 101 of the collapsible device 100 when the device 100 is in the first closed position 101. The first detent 622 may be a void, a dimple, notch or the like in the rail engaging portion 610 of the second housing 120 that is adapted to receive the spring finger 620 or at least a portion thereof.

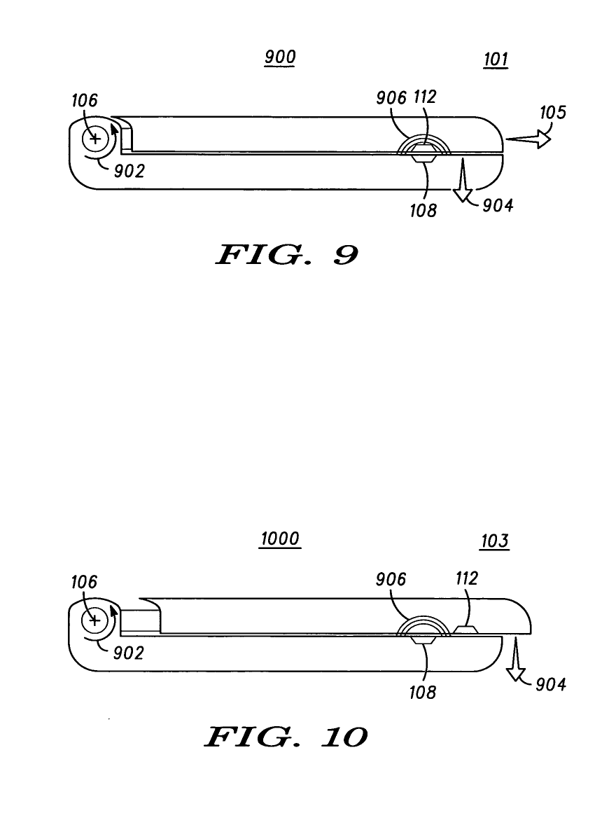

In another exemplary embodiment, the rail engaging portion 610 includes a second detent 624 which is laterally separated from the first detent 622 along the rail engaging portion 610. For example, the first detent 622 is at a first end 626 of the rail engaging portion 610 and the second detent 624 is at a second end 628 distal to the first end 626. In this embodiment, the spring finger 620 engages the second detent 624 selectively affixing the position of the second housing 120 relative to the first rail 602 at a second rail position 1000 (FIG. 10). In this exemplary embodiment the second rail position 1000 corresponds to the second closed position 103 of the collapsible device 100 when the device 100 is in stacked configuration.

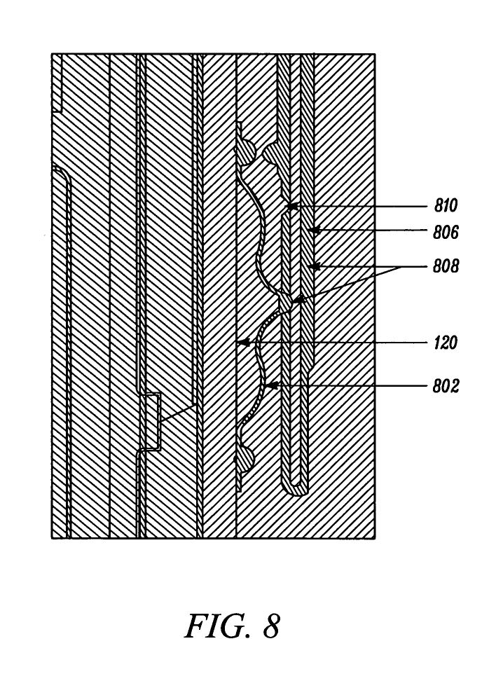

In exemplary embodiment of the spring finger, shown in FIG. 8, the spring finger 802 is carried on the first engaging portion 804 of the second housing portion 120. In this exemplary embodiment, the first rail 806 has a first detent 808 and a second detent 810. In the exemplary embodiment shown in FIG. 8, the spring finger 802 is engaged with the first detent 808 while in the first closed position 101. As the second housing 120 is moved from the first closed position 101 to the second closed position 103, the spring finger 802 slides out of the first detent 808 across the rail portion between the two detents 808, 810 to the second detent 810, thereby temporarily holding the second housing in the relative positions.

Whether the spring finger is carried on the rail 602,604, or a portion of the second housing 120, or the slid enabling portion coupled to the second housing 120, moving the second housing 120 from the first closed position 101 to the second closed position 103, engages the spring finger 610, 802, i.e. slides into the first detent 614, 808 thereby temporarily or selectively holding the second housing 120 in the first rail position 616, which corresponds to the second closed position 103. The fixturing force (not shown) of the fixturing portion 620 on the detent 614 holds the second housing 120 in place until a lateral force on the second housing overcomes the fixturing force and the second housing 120 slides lateral along the rail.

In another exemplary embodiment two fixturing portions are included, one on each of the two rails 602 and 604. A first fixturing portion 620 and a second fixuring portion 622, both mechanically fixturing the second housing 120 in at least one predetermined position along the rails 602, 604 as discussed above. The first fixturing portion 620 and a second fixuring portion are symmetric in that they align with detents in the same relative position to the second housing 120. Two fixturing portions provide a greater fixturing force to hold the second housing in the give position along the rail, and reduce torquing of the second housing relative to the first rail 602 and the second rail 604. The fixturing portion 620 and 622 only temporality fixture the second housing 120 along the rails until overcome by an external force such as the user's hand sliding the second housing or another mechanical force.

The spring finger 610, 802 may be made of plastic or metal or any material that provides a suitable spring factor to maintain position in the detent until overcome by a predetermined force. The spring finger 610 may be a piece of sheet metal such as spring steel for example that has a width substantially the same size as the first rail 602. In the exemplary embodiment shown in FIG. 6 the spring finger 610 has a detent engaging portion at a first end of the spring finger 610. The spring finger 610 is coupled to the first rail 602 at least at a second end of the spring finger 610. The spring finger 610 may be coupled by a rib and slot wherein the spring finger 610 has a rib (not shown) that slides into a slot (also not shown) of the rail. The spring finger may also be glued or screwed to the rail or may be formed into the rail as a portion thereof.

In yet another embodiment, the fixturing portion 620 may be a protrusion of the rail 602, 604. The rail is formed with the fixturing portion and the rail 602, 604 is compliant such that the rail 602 604 bends as the fixturing portion 620 slides in and out of the detents 622 and 624. In this exemplary embodiment the fixturing portion is a rounded portion of the rail configured to engage with the detents 622 and 624.

As discussed above the first and second housing, 110 and 120 are held together in the first closed position by engaging members. Lateral movement of the second housing 120 relative to the first housing 110 changes the relative position of the first engagement member 108 and the second engagement member 112. Upon the lateral movement of the second housing 120 in a radial direction relative to the rotation axis 106 along the first rail 602 and the second rail 604, the first engagement member 108 is disengaged from the second engagement member 112. In the first closed position 101 the first engagement member 108 is substantially adjacent to the second engagement member 112. When the second housing 120 is laterally moved to the second closed position 103, the first engagement member 108 is moved from the second engagement member 112 effectively disengaging the first engagement member 108 from the second engagement member 112. For example, in one exemplary embodiment the user slides the second housing 120, while in the first closed position 101, to the second closed position 103. The first engagement member 108 disengages from the second engagement member 112, and the user may open the collapsible housing 100 to the first open position 200. When the first engagement member 108 and the second engagement member 112 are substantially aligned, they engage one another as well as the first housing 110 to the second 120 so as to maintain the closed position 101.

Referring now to the exemplary embodiments of FIGS. 9-10, the collapsible housing 100 automatically opens to the first open position 302, from the second closed position 103, as a result of the biasing force 902 of the biasing member 104, 302 on the first housing 110 and the second housing 120. In this exemplary embodiment, as the user slides the second housing 120 to the second closed position 103, the biasing force 902 overcomes the engaging member force 904, and the first housing 110 and the second housing 120 angularly configure when the user's hand lets go of the second housing 120.

In FIG. 9 and 10 and in reference to FIG. 1, the first engagement member 108 is a magnet and the second engagement member 112 is a magnetically attracted member such as a non magnetic ferrous material so as to draw and hold the first housing to the second housing in order to maintain the first closed position 101. In the exemplary embodiment shown in FIG. 1, and FIGS. 9-10, the first engagement member 108 is a first magnet and the second engagement member 112 is a second magnet oriented such that it is attracted to the first magnet when substantially adjacent. When the first magnet 108 is laterally moved relative to the second magnet 112, the attractive force due to the magnetic field 906 reduces as a function of relative distance between the two magnets. Additionally, the spring force of the torsion spring 302 of the hinge 102 overcomes the engaging member force or attractive force 904 of the magnetic field 906, when the two magnets are laterally separated, 105 (FIG. 10) allowing the first housing 110 to rotate relative to the second housing about the rotation axis 106 to the open position 200.

In the first open position 200, a mechanical stop 208 may set the angle of the angular configuration of the first housing 110 relative to the second housing 120 thereby defining the first open position 200. The rotation angle 202 in the exemplary embodiment is between 0, the first and second closed position 101, 103 respectively, to the first open position 200. In this exemplary embodiment, the angle of the first open position is 165 degrees. A second open position (not shown) may be in-between the second closed position 103 and the first open position 200. The second open position may be defined by a soft mechanical stop such as a detent or cam mechanism in the hinge 102. In this embodiment, the first housing 110 would rotate about the rotation axis 106 to the second open position. The second open position shown is exemplary only and the angle may be in-between the second closed position and the first open position 200. In one exemplary embodiment, the second open position angle is between 5 and 10 degrees. This allows the user to at least partially insert a digit in grasp the second housing 120 and complete the opening motion to open the device 100 to the first open position 200.

In the first closed position 101 the magnetic field 906 of the magnet 108 is strong enough to overcome the biasing member force 902 thereby holding the first housing 110 and the second housing 120 in the first closed position 101. This is a result of the attractive force 904 of the magnetic field 906 upon the ferrous engaging member carried on the second housing 120. When the second housing 120 is slid along the slide enabling member 104 to the second closed position 103, (FIG. 10) the biasing member force 902 overcomes the attractive force 904 of the magnetic field 906 and the biasing member 302 automatically opens the device 100, angularly configuring the second housing 120 from the first housing 110.

In this exemplary embodiment the first engaging member 108 is a non-magnetic ferrous material which is magnetically attracted to the second engaging member 112 which is a magnet. It should be understood that the first engaging member 108 may be the magnet which magnetically attracts the non-magnetic ferrous material of the second engaging member 112. It should also be understood that both engaging memebre may eb magnets. As the ferrous material 108 is moved away from the magnet 112, when the housing is configured to the second closed position 1000 for example, the ferrous material is moved from the magnetic field 906 thereby effectively disengaging the ferrous material 108 from the magnet 112. When the collapsible housing 100 is in the first closed position 900, the magnetic attraction between the magnet 112 and the ferrous material fastens the first housing 110 to the second housing 120.

In one exemplary embodiment, two magnets are carried in the first housing, a first magnet 108 on a first side of the first housing and a second magnet 112 on a second side of the first housing 110. Complimentary engaging members, a first engaging member 108 and a second engaging member 112 are carried on the second housing 120. In the first closed position 101, the first magnet 108 attractively aligns with the second magnet 112. In this embodiment the magnets may protrude from the first face 114 of the first housing 110 and provide a bearing surface for the interface between the first housing 110 and the second housing 120.

Whether one magnet or two is carried on the second housing 120, the magnet, or magnets, may be covered with a bearing surface material to reduce the friction between the magnet 108 and the second face 116 of the second housing 120 as the second housing 120 slides along the magnet 108 from the first closed position 101 to the second closed position 103.

In one exemplary embodiment, illustrated in FIG. 11, the magnets 1102, 1104, or the magnet 1102 and the ferrous material 1104 may be used to conduction electricity from the first housing to the second hosing 120 when they are substantially aligned together in the first closed position 101 for example. The first magnet 1102 is coupled to a conductor 1106 which is coupled to circuitry 1108 in the device 100. The second magnet 1104 is coupled to a conductor 1110 which is coupled to circuitry 1112 in the device 100A circuit is formed when the magnet 1102 is adjacent to the other magnet 1104 or ferrous material 1104. This circuit for example, may be used to send a signal to a microprocessor in the device 100 indicating that the device 100 is in the first closed position 101. The circuit may also be used to send signals to and from a user interface carried in the second housing 120. It is understood by one skilled in the art that the circuit may be used for a plurality of purposes.

FIG. 12 In one exemplary embodiment the magnet carried on the first housing 110 has a first sloped portion 1202 that extends above the first face 114. The second housing has a second sloped portion 1204 adapted to engage the first sloped portion 1202 of the magnet 1104. As the first housing 110 slides relative to the second housing 120 form the first closed position 101 to the second closed position 103, the first sloped portion engages the second sloped portion 1204 and leverage the first housing 110 to angularly displace from the second housing 120. In this exemplary embodiment, the first sloped portion top 1206 is a bearing surface on which the second face slides. In another alternative exemplary embodiment, the second sloped portion top 1208 may be the bearing surface and alternative to this, both tops 1206, 1208 may provide a bearing surface for the respective face 114, 116 to slide on as the housings 110, 120 move laterally.

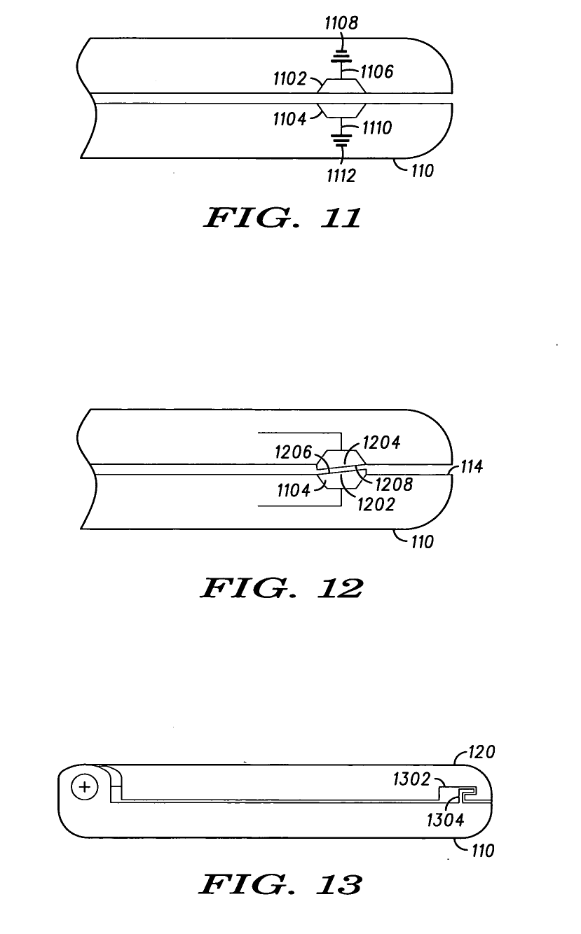

FIG. 13 In another exemplary embodiment the first engaging member 108 is a first latch 1302 and the second engaging member 112 is a second latch 1304. When the first housing 110 is moved relative to the second housing 120, the first latch 1302 would disengage from the second latch 1304. The first latch may be a hook and the second latch may be a hook receiver for example.

In the exemplary embodiment shown in FIG. 1-6, the second housing 120 slides longitudinally along the rail 104, relative to the first housing 110 from the first closed position 101 to the second closed position 103. The distance of travel of the second housing 120 along the slide enabling member 104 between the two closed positions is determined by physical stops on one of the second housing 120 or the slide enabling member 104 or a combination thereof.

In reference to FIG. 2 an exemplary device is shown in an exemplary first open position 200. In first open position 200, the second housing 120 is angularly displaced from the first housing 110 less than 180 degrees. It is to be understood that the exact angle may vary and is a choice of design. For example, the angle of displacement may be 180 degrees or 90 degrees, as one skilled in the art will under stand that various angles may embody the present invention.

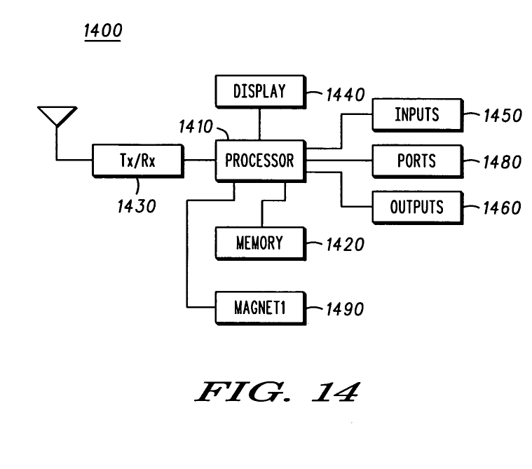

FIG. 14 is an exemplary wireless communications handset schematic block diagram 1400 comprising generally a processor 1410 coupled to memory 1420, for example RAM, ROM, EPROM, etc. The exemplary wireless handset also includes a radio transceiver 1430, a display 1440, optionally a second display, inputs 1450, for example a keypad, a microphone and video inputs, outputs 1460, for example a sound and tactile or haptic outputs, and other ports 1470, for example power, audio, etc., all of which are coupled to the processor. The magnet 1490 be coupled to ground and the ferrous material or second magnet may also be coupled to ground. The magnet may also be coupled to the processor 1410.

The various elements of the exemplary device 100, for example the processor, memory, inputs, outputs are disposed generally in a housing. The display is often mounted on the housing whether it is a part of a one piece assembly, or a multiple piece assembly where the housing elements move relative to one another. The housings may also include a keypad or keypads. The location and arrangement of these exemplary wireless handset elements is only an exemplary application and is immaterial to the structure of the hinges and spring biasing mechanisms, which are discussed more fully below.

While the present inventions and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

What is claimed is:

1. A collapsible housing comprising:
a first housing; and
a second housing moveably coupled to the first housing such that the first housing rotates relative to the second housing about a rotation axis and such that
the first housing moves radially relative to the rotation axis.

2. The collapsible housing of claim A1, further comprising an engaging member engaging the first housing to the second housing in a first closed position and disengaging the first housing from the second housing when the first housing is moved radially relative to the second housing to a second closed position.

3. The collapsible housing of claim A2, wherein the engaging member includes a magnet having a magnetic field carried on the first housing.

4. The collapsible housing of claim A2, further comprising a biasing member to exert a constant biasing force on the first housing to angularly displace the first housing form the second housing.

5. The collapsible housing of claim A3, wherein a magnetic attractive force resulting from the magnetic field is greater than the constant biasing force

6. A collapsible housing comprising:
a first housing;
a second housing;
a hinge coupled to one of the first housing or the second housing such that the first housing rotates relative to the second housing about a rotation axis of the hinge; and
a slide enabling member rotatably coupled to the hinge and slideably coupled to one of the first housing or the second housing which ever is not coupled to the hinge wherein the first housing or the second housing slides radially relative to the rotation axis.

7. The housing of claim 6, further comprising biasing [torsion spring] member coupled between the slide enabling member and one of the first housing or the second housing biasing the first housing to automatically angularly displace from the second housing about the rotation axis.

8. The housing of claim 7, wherein the biasing member biases the first housing relative to the second housing from a closed position wherein the first housing is planarly adjacent to the second housing to an open position wherein the first housing is angularly displaced from the second housing.

9. The housing of claim 8, wherein the biasing member biases the first housing to angularly displace from the second housing from the closed position to the open position.

10. The housing of claim 9, wherein the biasing member biases the first housing to angularly displace relative to the second housing to a first open position, and
wherein a detent holds the first housing in the first open position relative to the second housing.

11. The housing of claim 10, wherein the biasing member biases the first housing to angularly displace relative to the second housing from the first open position to a second open position.

12. The housing of claim 6, further comprising latching member carried on one of the first housing or second housing and substantially adjacent to one of the second housing of first housing whichever housing the latching member is not carried on when the first housing and second housing are configured in a closed position.

13. The housing of claim 12, further comprising a second latching member engageable to the first latching member, wherein the second latching member is carried on the one of the first housing or second housing, which ever the first latching member is not, and
wherein the second latching member is aligned with the first latching member when the first housing is in a first closed position relative to the second housing and offset from the first latching member when the first housing is in a second closed position relative to the second housing.

14. The housing of claim 13, wherein the first latching member is a first magnet.

15. The housing of claim 14, wherein the second latching member is a second magnet having the characteristic of being attracted to the first latching member.

16. The housing of claim 15, wherein the first magnet is coupled to ground and wherein the second magnet is coupled to ground.

17. The housing of claim 15, wherein a first magnet portion of the first magnet is a bearing surface for one of the first housing or the second housing such that one of the first housing or the second housing slides on the first magnet portion from the first closed position to the second closed position.

18. The housing of claim 17 wherein the first magnet includes an inclined portion configured to engage a portion of one of the first housing or the second d housing which ever the first magnet is not carried on.

19. The housing of claim 6, wherein the slide enabling member is a guide rail slidably engaged to the second housing portion and rotatably coupled to the first housing, wherein the second housing slides longitudinally relative to the slide enabling member and radially relative to the rotation axis.

20. The housing of claim 19, wherein the guide rail comprises a detent member selectively engageable to one of the first housing or the second housing.

21. The housing of claim 6, wherein the second housing comprises a roller bearing parallel to the axis or rotation.

22. The housing of claim 21, wherein the first housing comprises a external cam surface which engages the roller bearing.

23. An electronic device comprising:
a first housing;
a second housing;
a hinge coupled to one of the first housing or the second housing wherein the first housing rotates relative to the second housing about a rotation axis;
a rail rotatably coupled to the hinge and slideably coupled to one of the first housing or the second housing which ever is not coupled to the hinge wherein the first housing or the second housing slides radially relative to the rotation axis; and
a magnet carried on one of the first housing or the second housing; and
a ferrous material aligned with said magnet when the first housing is adjacent to the second housing.

24. The electronic device of claim 23, further comprising a biasing member, constantly biasing the first housing to angularly displace from the second housing.

25. The electronic device of claim 24, wherein a magnetic force between the magnet and the ferrous material is greater than a biasing force of the biasing member when the magnet is aligned with the ferrous material.

26. The electronic device of claim 25, wherein the biasing force of the biasing member is greater than the magnetic force when the first housing is in the second closed position relative to the first housing.

27. A method of opening a collapsible housing comprising:
sliding a first housing relative to a second housing form a first closed position to a second closed position; and
displacing a first magnet from a second magnet from a cooperatively aligned position when the first housing and the second housing are configured in the first closed position to a uncooperatively aligned position in response to sliding the first housing relative to the second housing wherein the attractive force of the first magnet to the second magnet are overcome by the rotational force of the spring biasing member coupling the first housing and the second housing together.
